(19) United States
(12) Patent Application Publication
(10) Pub. No.: US 2011/0044338 A1
(43) Pub. Date: Feb. 24, 2011

(54) THROUGHPUT IN A LAN BY MANAGING TCP ACKS

(76) Inventors: Thomas Anthony Stahl, Indianapolis, IN (US); Qingjiang Tian, West Lafayette, IN (US)

Correspondence Address: Robert D. Shedd, Patent Operations;THOMSON Licensing LLC, P.O. Box 5312, Princeton, NJ, 08543-5312, US

(21) Appl. No.: 12/312,950

(22) PCT Filed: Dec. 20, 2006
(86) PCT No.: PCT/US2006/048619

§ 371 Date: Jun. 2, 2009

(51) Int. Cl. H04L 12/56

(52) U.S. Cl. 370/392; 370/389

(57) ABSTRACT

A method and apparatus are described for managing acknowledgements, including identifying data packets and acknowledgements with a connection, determining which of the acknowledgements can be eliminated, replacing the acknowledgements that can be eliminated with a single acknowledgement and transmitting the single acknowledgement. An alternative method and apparatus are described for managing acknowledgements, including receiving a data segment, keeping track of connections, determining if there are enough data segments for a pre-determined number of channel time allocations and generating the acknowledgments for a selected connection if there are enough data segments for the pre-determined number of channel time allocations.

### FIELD OF THE INVENTION

The present invention relates to distribution of compressed multi-media/video from a master device such as a set top box (STB) to remotes devices such as STBs in a wireless video distribution system.

### BACKGROUND OF THE INVENTION

For cable video services, specific video programs are typically broadcast on the cable in their own dedicated frequency band. Any TV in the house can be tuned to any specific program by tuning to that frequency. In the case of newer TV services (e.g., satellite TV distribution, internet TV distribution), programs are “tuned” in a master STB and are then distributed to remote STBs over a home network. In many cases, a home network (or home distribution system) needs to be installed. Although wires (coax, twisted pair, etc.) are reliable, they can be expensive to install and homeowners may not like installers drilling through walls for the installation. With that in mind, the industry is interested in wireless solutions to the video program redistribution system problem.

Most existing in-home digital video distribution systems use Ethernet as the distribution media. Since most Ethernet installations use at least 100 Mbps link rates and use switches, which selectively transmit traffic only to the branch containing the addressed device, there are very few QoS issues when used in a video redistribution system with controlled traffic rates. There could be problems with Ethernet if one transmitted general IP data traffic on the same network without some type of QoS protection. There is currently one type of media access control (MAC) level QoS available for Ethernet. It is a priority based scheme, which uses the user priority field in the virtual local area network (VLAN) tag. The addition of parameterized QoS (bandwidth request, bandwidth guarantee, admission control, etc.) is currently the subject of one of the working groups within the IEEE 802.1 subcommittee on IEEE 802 network bridging. However, Ethernet has the disadvantage that it requires wires to be run and it is desirable to have a no-new-wires installation technology.

What is needed is a wireless distribution system that can replace the Ethernet distribution through MAC-level bridging. Many home networks distribute the video using IP protocols, but there are many possibilities. In some cases video is sent using UDP as specified by real time transport protocol (RTP), while in other cases (e.g., Digital Living Network Alliance (DLNA)) video is distributed over TCP. UDP requires only one way communication while TCP requires two-way communication. There are additional possibilities. It would be desirable to have a home distribution system that does not require any modifications to the master and remote devices/STBs when they already have an Ethernet interface (i.e., no bandwidth reservation, no talking to the wireless bridge devices, etc.). It is also desirable that the MAC layer be extremely efficient since the media is wireless and therefore a band-limited common media. For that reason, the present invention uses a TDMA MAC scheme. In a TDMA MAC scheme, time allocations are assigned resulting in dedicated bandwidth to each client/remote device (STB). As used herein, “/” indicates alternative names for the same component. The exact bit rates of the video and other characteristics may not be known, even to the master STB a-priori. Even if the exact bit rates of the video were known a-priori, it is desirable not to require the master STB have any special or new communication with the wireless devices (remote and/or master bridging nodes). Since the multi-media traffic is mostly downstream from the master device to a few remote devices, there is an opportunity to eliminate overhead. When TCP is used to distribute the multi-media stream, most of the upstream traffic is TCP ACKs. Eliminating some of these TCP ACKs will reduces the amount of overhead being transmitted allowing more of the available BW to be dedicated to actually carrying multi-media stream information.

Time allocated to the return/upstream path from a remote STB/device to the master device/STB is time that is not available for the downstream path for video distribution. Since video distribution is the main function of the target system, it is desirable to reduce the overhead caused by TCP ACKs and to reduce the negative effects of the TCP sliding window.

IEEE 802.11N, which is currently under standardization in the IEEE is being touted as a means for video distribution. There are a number of concerns with the technology that is the subject of IEEE 802.11N. First, it still is based on CSMA (IEEE 802.11). This type of MAC layer is inherently inefficient and provides no QoS guarantees. Although many MAC-level QoS enhancements are being added to IEEE 802.11N, it is unlikely that a CSMA based MAC can be as efficient as a TDMA MAC. QoS enhancements include the priority based QoS from IEEE 802.11E and some form of polling and the addition of MAC protocol data unit (MPDU) and MAC service data unit (MSDU) aggregation. These enhancements can be very useful in managing the resources of an IEEE 802.11 network, but do not make any QoS guarantees that are necessary or desirable for wireless home video distribution systems. The polling could be used to create TDMA-like services on which the present invention could operate, but the polling itself cuts into the MAC efficiency. MAC efficiency is even more critical for a wireless network because of the limited link rate available to the more remote areas of a house. Most current wireless local area networks (WLANs) utilize a common transmission media (i.e., wireless spectrum at the same transmission frequency). Because of that, the MAC needs a mechanism for sharing that media. It should be noted that once a transmission opportunity is acquired via CSMA or assigned via polling, the present invention may be applied.

Some service providers are looking at no-new-wire technologies based on coax, phone lines, and/or power lines. There are many different possibilities, most of the possibilities have some form of priority or parameterized QoS. The problems inherent with these solutions are that even though there may be coax or phone lines already in a house, those lines still may not be wired to the right spot or may be a topology that is difficult for the technology to handle. Most of these technologies also share bandwidth with other houses (e.g., power lines for up to 4 houses are on one power transformer) and currently lack reliability. For the parameterized service, the STB must know how much bandwidth to reserve for each link. For a video home distribution system, the traffic is not under control, may be bursty, and is at least partially unknown.

The present invention encompasses a home multi-media stream distribution system that solves the problems highlighted above.

### SUMMARY OF THE INVENTION

Most current Wireless LANs utilize a common transmission media (i.e., wireless spectrum at the same transmission frequency). Because of that, the media access control (MAC) layer needs a mechanism for sharing that media. Most mechanisms are based on a carrier sense multiple access (CSMA) MAC layer (e.g., IEEE 802.11). This type of MAC layer is inherently inefficient and provides no quality of service (QoS) guarantees. MAC efficiency is even more critical for a wireless network because of the limited link rate available to the more remote areas of a house. To achieve a very high efficiency and QoS guarantees, the present invention uses a MAC based on time division multiple access (TDMA) IEEE 802.15.3b. For basic TDMA functionality, a standard MAC is used, but the ability to reduce the network load due to TCP ACKs is added.

A typical system for which the present invention is designed includes a master device that distributes internet protocol (IP) based video to up to three client/remote devices. The devices are Ethernet/wireless MAC-level bridge devices with the actual video tuning and rendering being done in Ethernet based STBs. While the present invention is described in terms of STBs, any device with equivalent or like functionality is contemplated by the present invention regardless of the name for that device. In general, a MAC bridge connects LAN segments that could be the same or different. A collection of different LAN technologies that are interconnected by bridges is known as a bridge local area network. A pure MAC bridge operates below the MAC services boundary and is transparent to the protocols used above the MAC bridge services boundary, except for possibly differences in QoS.

The system and method of the present invention will be described in terms of an exemplary home video distribution system with restricted communication to three remote STBs (i.e., all communication to/from the master STB). The techniques described herein can easily be extended to a more general home network. It should be noted that to date, there are no wireless home distributions systems that can distribute three high-definition video streams to three remote locations in the house. It should also be noted that while the present invention is described in terms of an exemplary embodiment that includes video streaming, it should be readily apparent that the term “video” can be extended to include “multi-media stream” which includes other streaming media such as digital audio.

All traffic is restricted to go to/from the master bridging device. The master bridging device transmits a beacon periodically that maps out the channel time allocations (CTAs) within which each device transmits its data. The beacon plus all of the CTAs up to the next beacon is called a “superframe” as illustrated in FIG. 8. CTA 1, 2, & 3 are for downstream traffic (mostly video). CTA 4, 5, & 6 are for upstream traffic (mostly TCP acknowledgments (ACKs) and other management/control frames). The master bridge device determines the CTA allocations prior to beacon transmission. In general, the CTAs could be fixed time slots either determined by the master device (master STB) or requested by the remote device (remote STBs). It is desirable to make full use of all available time allocations/slots.

The present invention also has the advantage that it does not require any change to the video system middleware, including the protocols carrying the video.

In the above described application, video is distributed over TCP, which is a connection oriented bi-directional protocol that is layered over IP in a protocol stack. Although the TCP ACKs are useful for transmission through the internet, their usefulness in a reliable LAN for use in video streaming as in the present invention is questionable. TCP, however, is what is available as middleware in a bridging device and it is desirable not to alter existing middleware but rather to augment and enhance it. High reliability can be achieved through low physical layer (PHY) packet error rate and re-transmission at the MAC layer. It is also desirable to reduce overhead caused by TCP ACKs being returned by a remote STB and the negative effects on the TCP sliding window.

Described herein are three methods for reducing the overhead caused by the TCP ACKs. The first two methods are combined to form the third method. Since the exemplary embodiment of the present invention (for description purposes) is based on a TDMA MAC, transmissions from the remote STB to the master STB occur in bulk every 5 or 10 msec depending on the length of a superframe. For this transmission, the remote STB takes packets out of its transmit queue and assembles them into a series of frames (or aggregated frames) for transmission. In this exemplary embodiment, all of this traffic is destined for the master STB. For the first method, the remote bridge device examines the IP and TCP headers of frames in its transmit queue and determines which of the ACKs can be eliminated. Depending on the contents of the frames, several TCP ACKs are replaced with one TCP ACK. This allows for a shorter CTA being allocated to the remote devices/STBs leaving more time for the CTAs assigned to the master device/STB and therefore more time allocated for downstream video.

In the second method, TCP ACKs back to the master STB are generated by the master bridge device. In this case, the master STB is fooled into thinking that the packet has already been received by the remote STB. The master bridge device keeps track of the TCP sliding window, TCP sequence numbers, the maximum segment size (MSS) and its own transmit queue. If TCP frames are arriving too often from the master STB, then the master bridge device withholds a TCP ACK until the queue level decreases. This is a form of flow control. The master bridge device also intercepts the TCP ACKs actually being returned from the remote STB to make sure they are not forwarded to the master STB. Alternatively, the TCP ACKs can be intercepted by the remote bridge device and a summary report can be sent to the master bridge device if necessary. It is also possible that the remote bridge device discards the intercepted TCP ACKs. This second method has the advantage of being able to reduce the negative effects of a small TCP sliding window in addition to reducing overhead.

The third method combines the two methods described above. The TCP ACKs are generated locally by one of the bridge devices (master or remote) as in the second method, however the TCP ACKs being returned by the remote STB are combined as described in the first method. These methods could be considered crosslayering since they involve MAC, IP, and TCP layers/functions and reside in the bridge/MAC layer. The benefit is reducing negative effects of streaming over TCP while requiring no change to the STBs. The bridge devices identify and perform a limited amount of TCP/IP processing. For general data network traffic, the industry has for the most part kept all of the layers separate and independent. The MAC layer is usually not aware of the type of data traffic being carried in the payload of its frames. For example, an Ethernet switch for the home has no knowledge of TCP or IP and, in fact, usually requires no setup. The bridge is transparent to the network and operates at the MAC layer. No prior art method of any distribution system aims at reducing TCP ACKs through MAC/Bridge layer involvement.

A method and apparatus are described for managing acknowledgements, including identifying data packets and acknowledgements with a connection, determining which of the acknowledgements can be eliminated, replacing the acknowledgements that can be eliminated with a single acknowledgement and transmitting the single acknowledgement. An alternative method and apparatus are described for managing acknowledgements, including receiving a data segment, keeping track of connections, determining if there are enough data segments for a pre-determined number of channel time allocations and generating the acknowledgments for a selected connection if there are enough data segments for the pre-determined number of channel time allocations. Yet another alternative method that is a combination of the above two methods is also described.

### BRIEF DESCRIPTION OF THE DRAWINGS

The present invention is best understood from the following detailed description when read in conjunction with the accompanying drawings. The drawings include the following figures briefly described below:

FIG. 1 is an exemplary wireless home video distribution system in accordance with the principles of the present invention.

FIG. 2 is a MAC-level bridge.

FIG. 3 is a general wireless bridge.

FIG. 4 is a wireless bridge having constrained paths suitable for wireless home video distribution in an exemplary embodiment of the present invention.

FIG. 5 is a block diagram of the software (logical structure) of the master STB and the server side of the wireless MAC bridge.

FIG. 6 is a block diagram of the software (logical structure) of the remote/client STB and the client side of the wireless MAC bridge.

FIG. 7 is a block diagram of a wireless MAC bridge showing how DTAs are used in accordance with the principles of the present invention.

FIG. 8 depicts a superframe in accordance with the present invention.

FIG. 9 is a high level transmit packet flow diagram for the PNC connected to the video server (master STB).

FIG. 10 is a high level receive packet flow diagram for the PNC connected to the video server (master STB).

FIG. 11 is high level transmit packet flow diagram for a DEV-x connected to a video client (remote STB).

FIG. 12 is a high level receive packet flow diagram for a DEV-x connected to a video client (remote STB).

FIG. 13 depicts a single downstream CTA (PNC to DEV-x).

FIG. 14 depicts SuperMAC (a non-standard aggregation of MAC Frames) and physical frame formatting.

FIG. 15 depicts a single upstream CTA (DEV-x to PNC).

FIG. 16 depicts TCP/IP encapsulation.

FIG. 17 depicts an IP header.

FIG. 18 depicts a TCP header.

FIG. 19 depicts TCP sliding window operation.

FIG. 20 is a high level flowchart of an exemplary embodiment of processing at a remote bridging device.

FIG. 21 is a high level transmit flowchart of a second exemplary embodiment of processing at a master bridging device.

FIG. 22 is a high level flowchart of forwarding remote acknowledgements (ACKs) in a master bridging device.

FIG. 23 is a high level flowchart of the second embodiment at the remote bridging device.

### DETAILED DESCRIPTION OF THE PREFERRED EMBODIMENTS

The present invention starts with an IEEE 802.15.3b MAC, which supports TDMA services (beacon at beginning of the superframe with transmission time allocations within the superframe). IEEE 802.15b was designed to be a personal are network and is, therefore, “lighter” than those technologies designed for LANs or metropolitan area networks (MANs). Although other TDMA MACs are available and can be used (e.g., IEEE 802.16), there have been no attempts in the prior art to allocate CTA lengths dynamically purely based on traffic characteristics available to the MAC layer. IEEE 802.16 was designed for wireless metropolitan area networks (WMANs) and is used for internet distribution to service subscribers. It contains many features and options allowing service providers to customize their networks. While the exemplary embodiments of the present invention are described with respect to IEEE 802.15.3b, the concepts could be applied equally well to IEEE 802.16 embodiments. There are a few more headers to parse through.

There are some features of TCP that must be considered when setting up CTAs. TCP is a transport protocol that makes use of 32 bit sequence numbers, request numbers, and a 16 bit sliding window length field. These three numbers are used to implement a “Stop-and-Wait” or “Go-Back-N” ARQ error recovery scheme. Since TCP packets in the transmit queue and in the process of being transmitted are “in the network,” the TCP window must be set large enough by the destination to allow those packets to be outstanding. In general, a MAC-level bridging device has no control over setting that window size, however the initial choice of CTAs and superframe length can be chosen short enough to minimize problems. The length of the superframe may be made adjustable (or adaptable) to be able to handle varying TCP window sizes.

For a 10 msec superframe, approximately nineteen 1400 byte TCP packets are transmitted every 10 msec. This accounts for 26,600 bytes. A transmit buffer queue of approximately 165 kbytes has been chosen for purposes of the following description of the exemplary embodiment. For TCP traffic, the transmit buffer queue will never overflow because the TCP window size will not allow more than 64 kbytes of outstanding data. It is even possible that the window may be small enough to not even allow a CTA to be completely filled. For this reason, it is better to start off with a short superframe (5 msec). The transmit buffer queue then need not be bigger than 51 kbytes, at least to be able to handle a single TCP session. However, the 165 kbyte transmit buffer queue was chosen to avoid lost packets in the case of video send over UDP.

Note that mathematical models of ARQ error recovery schemes have been developed within the field of queueing theory and can be used to model the TCP performance more precisely if needed. It is assumed that the window size is large enough to allow enough outstanding TCP packets for some to be in the queue while others are in the CTA. In the exemplary embodiment up to five retransmissions are permitted, the CTA should be small enough that about five times the data can be sitting in the transmit buffer queue. A 5 msec superframe would accomplish this if a maximum size TCP window were used.

While the initial application will be streaming video using TCP, there is enough uncertainty of the implementation that the only way to guarantee good performance in the general sense is to allow it to adapt to the traffic pattern.

Real-time length-flexible superframe construction is possible, which is believed to increase system robustness and improve system performance. The length of the superframe may depend on the length of three individual video queues in the exemplary embodiment, downstream transmission channel condition, and any other possible issues. In the case of a length-flexible superframe, the beacon must broadcast the length of the following CTAs and each remote STB is informed about the length of the CTAs dedicated to it.

As noted above, it is possible that if the TCP receive window is small enough with respect to the length of the CTA, that the server will not release the next packet until receiving an ACK from a previous packet, effectively slowing down the stream at the source. The rate could fall below the desired real-time streaming rate. To avoid this, the present invention selects CTA size that does not result in this starved condition. To maintain the proper rate, the CTA needs to occur more often if it is reduced in size. This occurs by reducing the size of the superframe or by allocating more than one CTA to that link per superframe.

As further noted above, the uncertainty on the TCP window size leads to the possibility of varying the superframe length. This can be done at the MAC layer by triggering a superframe change based on looking at the TCP header or more properly by monitoring the transmit buffer queues and shortening the superframe if the transmit buffer queues empty too often leaving the CTA short of data to transmit. Initially a fixed superframe length was used in the exemplary embodiment. Given a fixed superframe length, modifying CTA lengths to adapt to traffic characteristics is investigated. In that case, there is some uncertainty of how much time to allocate to those CTAs mostly meant for TCP ACKs, since the TCP stack in the STB may group ACKs and/or may include the ACK in the header of a packet containing data.

At a bare minimum, it is known the average output packet rate of any given transmit queue must be kept below the average packet arrival rate, otherwise, the queue will overflow. However, even with the average arrival rate being less than the average departure rate, it is possible for the input rate to temporarily exceed the output rate due to the statistical nature of the input stream. Keeping the average output rate higher than the average input rate is necessary, but not sufficient. It is best to make the system adaptive due to the lack of specificity of the IP traffic.

To allow for adaptation, queue information for every superframe is recorded. Queue information includes the size of queue (if fixed, no need to send), the number of packets in queue, the average length of packets in queue, and an estimate of the input packet rate. This information along with information on reliable link rates to each DEV/remote STB is used as input to an adaptive algorithm whose goal is to not drop packets and to distribute the superframe time to CTAs in a way that reaches that goal. The adaptation algorithms strive to minimize the expected number of packets in each queue (and hence minimize delay) and/or minimize the probability that a queue overflows. By monitoring the queue level, the MAC may adjust the CTA every superframe to give transmit preference to the queue that is most full.

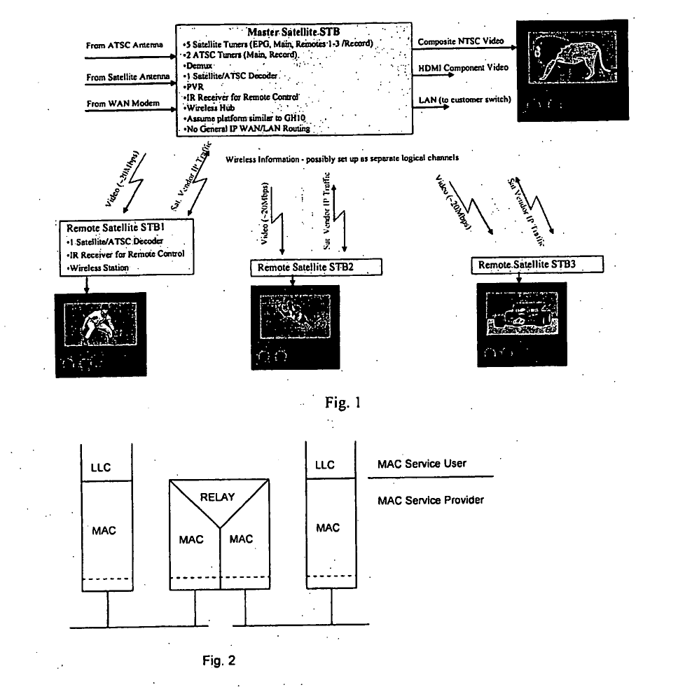

The present invention concerns the MAC and bridging layers of a wireless video service distribution system, which distributes compressed video from a master STB to remote STBs. The system makes partial use of an IEEE 802.15.3b TDMA MAC and therefore uses some of the terminology from that standard. An exemplary system with the technology built into the STBs is shown in FIG. 1.

The master STB 105 receives input from a variety of sources of video including an Advanced Television Systems Committee (ATSC) antenna (digital TV), a satellite antenna and a wide area network (WAN) modem. The master STB provides output to a video display 110 (for example, TV) including a composite National Television Standards Committee (NTSC) video display, High-Definition Multimedia Interface (HDMI) component video display and a local area network (LAN) connected to a customer switch. The master STB has 5 satellite tuners (electronic program guide (EPG), main, three remote tuners and a recording tuner). The main tuner is for tuning to the program that the user of the display in communication with the master STB desires. The three remote tuners are for tuning to the programs that each of the users of the remote displays desire. The EPG tuner is for tuning to the electronic program guide. The recording tuner is to tune to a program that the user of the display in communication with the master STB wants to record while he/she is watching the program tuned to by the main satellite tuner. The master STB has two ATSC tuners—a main tuner and a recording tuner. The main tuner is for tuning to the program that the user of the display in communication with the master STB desires. The recording tuner is to tune to a program that the user of the display in communication with the master STB wants to record while he/she is watching the program tuned to by the main ATSC tuner. The master STB also has a demultiplexer (demux), a personal video recorder (PVR), an infrared (IR) receiver for use with a remote control device, a satellite/ATSC decoder and a wireless hub. Master STB 105 can transmit video to each remote STB at about 20 Mbps. Master STB 105 can exchange satellite vendor IP traffic with each remote STB. Master STB 105 can exchange control information with each remote STB.

The master STB is in communication with three remotes STBs (remote STB1 115, remote STB2 125 and remote STB3 135). Remote STB1 115 is in communication with a video display 120. Remote STB2 125 is in communication with a video display 130. Remote STB3 135 is in communication with a video display 140. The remotes STBs are similarly configured so only remote STB1 will be described. Remote STB1 115 has a satellite/ATSC decoder, an IR receiver for use with a remote control device and a wireless station. Remotes STB1 115 can receive video from master STB 105 at about 20 Mbps. Remote STB1 can exchange satellite vendor IP traffic between itself and master STB 105. Remote STB1 115 can exchange control information with master STB 105.

The present invention is built as a MAC-level wireless bridge (see FIG. 2). In general, a MAC bridge connects LAN segments that could be the same or different. A collection of different LAN technologies that are interconnected by bridges is known as bridge local area network. A MAC bridge operates below the MAC services boundary and is transparent to the protocols used above the MAC bridge services boundary, except for possibly differences in QoS. The MAC services user is above the MAC services boundary and the MAC services provider is below the MAC service boundary. The MAC layer bridge includes a relay to interface with each LAN segment/component.

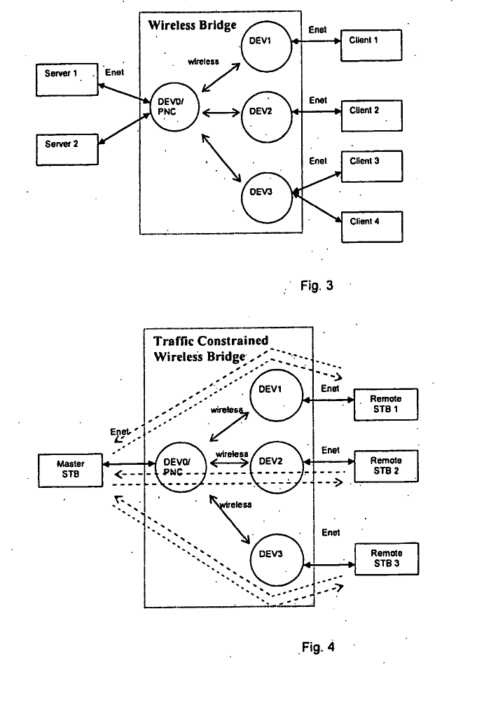

A general wireless bridge is shown in FIG. 3. Wireless bridge 305 is in communication with servers via Ethernet connections. Two servers 310, 315 are shown. Wireless bridge 305 is also in communication with clients via Ethernet connections. Four clients 320, 325, 330, 335 are shown. Within the general wireless bridge is DEV0, which is a piconet controller (PNC) 340. PNC 340 is in communication with a plurality of devices wirelessly. Three devices DEV1 345, DEV2 350 and DEV3 355 are shown. DEV0/PNC 340 is in communication with server 310, 315. DEV1 345 is in communications with client 320. DEV2 350 is in communication with client 325. DEV3 355 is in communication with clients 330, 335.

The exemplary embodiment of the present invention, however, has constrained paths suited for a wireless home video service distribution application. Possible data paths are shown by dashed lines in FIG. 4. Wireless bridge 405 is in communication with master STB 410 wirelessly. Wireless bridge 405 is also in communication with remote STBs 415, 420, 425 wirelessly. Wireless bridge 405 internally is configured as shown in FIG. 2. All traffic goes to/from master STB 410.

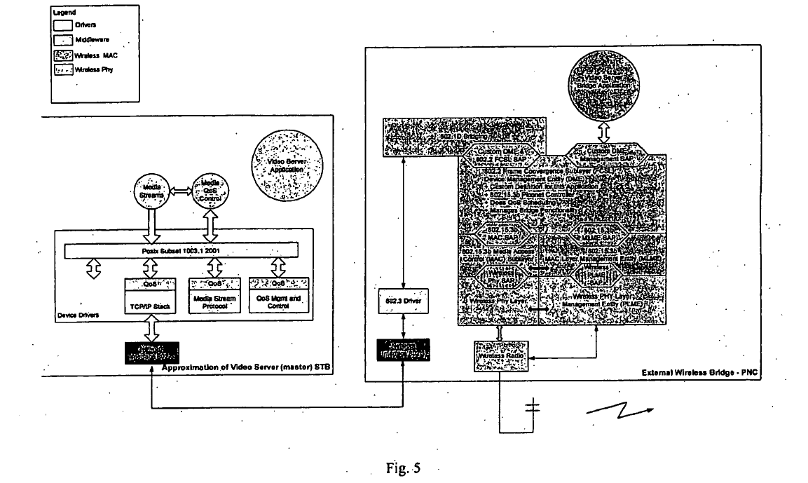

FIG. 5 shows the software architecture of the server side (master STB and bridge device). It is noted that the master bridge device is also the piconet controller (PNC) as described in IEEE 802.15.3. The master STB 505 has a middleware video server application 510 in the master STB 505. Multi-media stream middleware 515 interfaces with both media QoS control 520 and device drivers 525. Multi-media stream middleware 515 forwards video data to device drivers 525 and exchanges control information with Media QoS control middleware 520. Media Qos control middleware exchanges control information with device drivers 525. Device drivers 525 exchange primarily video data with network interface (IEEE 802.3) 530. Within device drivers 525 are a subset of portable operating system Unix (POSIX) drivers 535 for receiving video data and control information from media stream middleware 515 and exchanging information with media QoS control middleware 520. The subset of POSIX drivers exchange information with QoS middleware that is in a stack with TCP/IP 540 and media stream protocol 545 and QoS management and control 550. The PNC 555 has a wireless MAC video server bridge application 560, which exchanges control information with software 565, which includes a plurality of software modules. Software 565 exchanges video data and control information with wireless radio interface 570 and with IEEE 802.3 driver 575. IEEE 802.3 driver exchanges primarily video data with IEEE 802.3 network interface 580, which interfaces and exchanges video information with IEEE 802.3 network interface 530. Software 565 includes a number of software components including an IEEE 802.1D bridging module, which is layered on a wireless device management entity (DME) and IEEE802.2 frame convergence sublayer (FCSL) service access point (SAP). Wireless MAC video server bridge application 560 interfaces with wireless DME management SAP. Both wireless DME management SAP and wireless DME and IEEE 802.2 FCSL SAP are layered over the IEEE 802.2 FCSL DME, which performs the functions of an IEEE 802.15.3b PNC, does QoS scheduling and manages bridge functionality. The IEEE 802.2 FCSL DME is layered over an IEEE 802.15.3b MAC SAP and an IEEE 802.15.3b MAC layer management entity (MLME) SAP. The IEEE 802.15.3b MAC layer management entity (MLME) SAP is layered over an IEEE 802.15.3b MLME, which is layered over the wireless physical layer management entity (PLME) SAP. The IEEE 802.15.3b MAC SAP is layered over the IEEE 802.15.3b MAC sublayer, which is layered over the wireless physical SAP. The IEEE 802.15.3b MAC SAP is layered over the wireless physical layer. The wireless physical layer management entity (PLME) SAP is layered over the wireless physical layer PLME. The wireless PLME is in communication with the wireless physical layer. The IEEE 802.15.3b MAC sublayer is in communication with the IEEE 802.15.3b MLME. Both the wireless physical layer and the wireless PLME exchange video data and control information respectively with the wireless radio interface

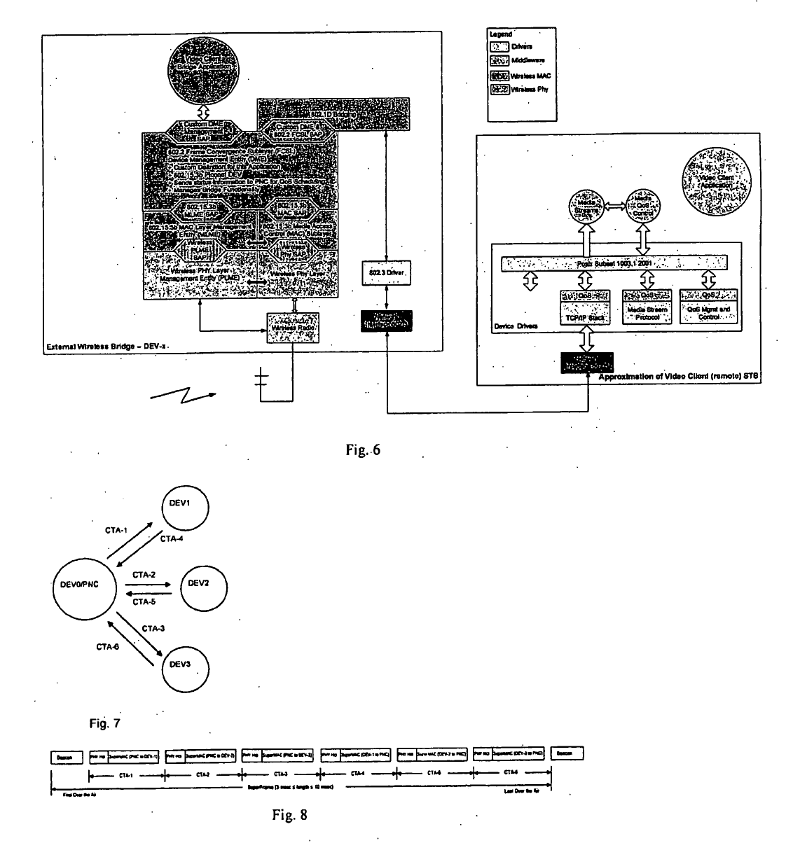

FIG. 6 shows the SW architecture for the client side (Remote STB and Bridge Device). Note that the present invention is in the bridge devices, but the STBs are shown for context. It is noted that the remote/client bridge device is also a DEV-x (non-PNC device) as described in IEEE 802.15.3. The remote/client STB 605 has a middleware video client application 610 in the remote/client STB 605. Media stream middleware 615 interfaces with both media QoS control 620 and device drivers 625. Media stream middleware 615 accept video data to device drivers 625 and exchanges control information with Media QoS control middleware 620. Media QoS control middleware exchanges control information with device drivers. Device drivers 625 exchange mostly video data with network interface (IEEE 802.3) 630. Within device drivers 625 are a subset of POSIX drivers 635 for sending primarily video data to media stream middleware 615 and exchanging information with media QoS control middleware 620. The subset of POSIX drivers exchange information with QoS middleware that is in a stack with TCP/IP 640 and media stream protocol 545 and QoS management and control 650. The DEV-x 655 has a wireless MAC video client bridge application 660, which exchanges video data and control information with software 665, which includes, a plurality of software modules. Software 665 exchanges video data and control information with wireless radio interface 670 and with IEEE 802.3 driver 675. IEEE 802.3 driver exchanges primarily video data with IEEE 802.3 network interface 680, which interfaces and exchanges that video data with IEEE 802.3 network interface 630.

Software 665 includes a number of software components including an IEEE 802.1D bridging module, which is layered oh a wireless DME and IEEE 802.2 FCSL SAP. Wireless MAC video client bridge application 660 interfaces with wireless DME management SAP. Both wireless DME management SAP and wireless DME and IEEE 802.2 FCSL SAP are layered over the IEEE 802.2 FCSL DME, which performs the functions of an IEEE 802.15.3b DEV-x, sends status to the PNC for QoS scheduling and manages bridge functionality. The IEEE 802.2 FCSL DME is layered over an IEEE 802.15.3b MAC SAP and an IEEE 802.15.3b MLME SAP. The IEEE 802.15.3b MLME SAP is layered over an IEEE 802.15.3b MLME, which is layered over the wireless physical layer management entity (PLME) SAP. The IEEE 802.15.3b MAC SAP is layered over the IEEE 802.15.3b MAC sublayer, which is layered over the wireless physical SAP. The IEEE 802.15.3b MAC SAP is layered over the wireless physical layer. The wireless PLME SAP is layered over the wireless physical layer PLME. The wireless PLME is in communication with the wireless physical layer. The IEEE 802.15.3b MAC sublayer is in communication with the IEEE 802.15.3b MLME. Both the wireless physical layer and the wireless PLME exchange video data and control information with the wireless radio interface. It is software 665 and 660 that receive a beacon signal with information on CTAs, receive the redistributed video/media within those downstream CTAs and transmit MAC-level ACKs or NAKs in the appropriate upstream CTA. Note that these ACKs are different than TCP ACKs that may be generated at the Video Client when TCP is used.

Referring now to FIG. 7, which is a block diagram of a wireless MAC bridge in accordance with the principles of the present invention. PNC 705 transmits and receives data/information to/from the remote STBs 710, 715, 720 in the assigned CTAs. The master device 705 transmits a beacon periodically that maps out the channel time allocations (CTAs) within which each device transmits it's data. CTA 1, 2, & 3 are for downstream traffic (mostly video). CTA 4, 5, & 6 are for upstream traffic (mostly TCP ACKs and other management frames).

Superframe is shown in FIG. 8. The master device determines the CTAs prior to beacon transmission. In general, the CTAs could be fixed time slots either determined by the master device/PNC or requested by a remote device/STB. Specifically, for IEEE 802.15.3b, the standard specifies the remote STBs/devices to request bandwidth by sending a “CTReq” message to the PNC. However, whatever CTA time is requested or set, none of the devices really knows all of the IP traffic characteristics a-priori, especially the remote STBs. The traffic could be based on UDP (no returning ACKs) or could be based on TCP. At times, all of the traffic could be downstream while at other times, it could be somewhat symmetric. It is desirable to make full use of all available time by adapting the amount of time within CTAs to optimize traffic flow. The leftmost portion of the superframe is transmitted over the air first and the rightmost portion of the superframe is transmitted over the air last. Following the beacon, the CTAs are transmitted in order with the downstream CTAs being transmitted first and the upstream CTAs being transmitted thereafter. Superframes in the context of the present invention can vary between 5 msec and 10 msec.

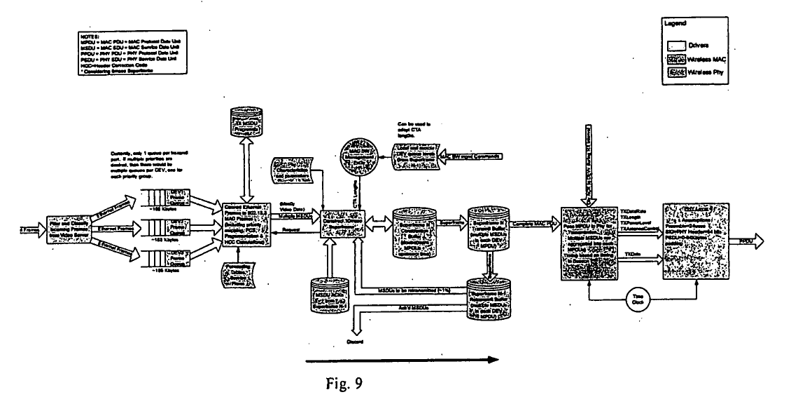

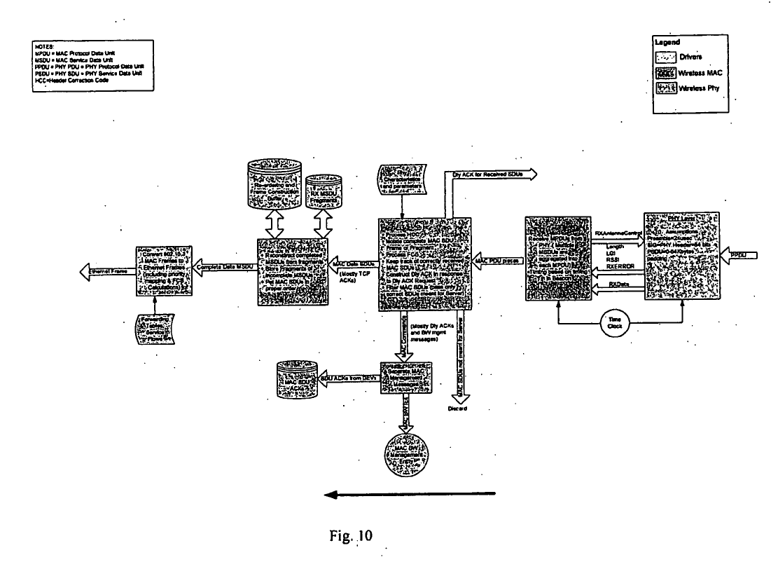

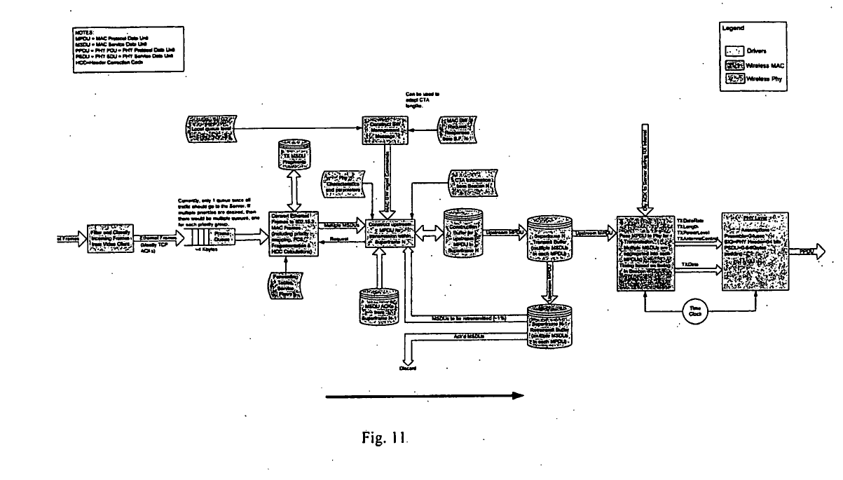

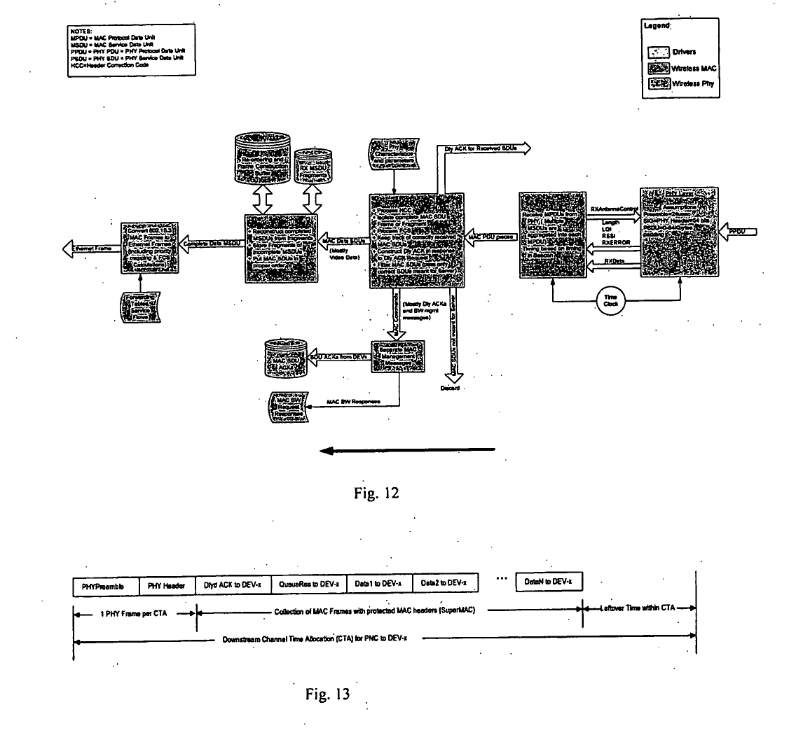

Exemplary packet flow diagrams for the PNC connected to the master STB are shown in FIGS. 9 and 10. Exemplary packet flow diagrams for a DEV-x (i.e., non-PNC device) connected to a remote STB are shown in FIGS. 11 and 12. As has been described above, the wireless MAC bridge of the exemplary high definition video distribution system acts as a constrained bridge.

Referring now to FIG. 9, the PNC receives Ethernet video data frames on the Ethernet port (mostly video) 905. The PNC determines the length of the superframe and each CTA. It places the frame in the proper transmit queue 910a, 910b, 910c depending on the destination MAC address. The PNC can either learn the MAC address through flooding as described in IEEE 802.1D or the filtering/routing tables can be filled manually. For purposes of reducing clutter on the figure, the present invention is described assuming only one queue, per transmit port (destined for each DEV-x/remote STB). If multiple priorities are desired, then there would be multiple queues per transmit port (destined for each DEV-x/remote STB). That is, one queue for each priority group. The Ethernet video data frames are divided into the queues. In the exemplary embodiment the queues are 165 kbytes each and the superframe is between 5 msec and 10 msec long. The video data frames from the queues are forwarded to a software module 915 that converts the Ethernet video data frames to IEEE 802.15.3b MAC frames including priority mapping, frame check sequence (FCS), fragmentation and header correction code (HCC) calculations. The software module 915 receives forwarding tables and service flows to process the received Ethernet video data frames from data storage unit 920. Software module 915 is in communication with a buffer 925 for storing the transmit MAC service data units (MSDUs). Software module 930 requests the MAC frames from software module 915 in order to construct the superframe. Software module 915 forwards multiple MSDUs to software module 930. Software module 930 receives physical characteristics and parameters from data storage unit 935 and MSDUs acknowledgments (ACKs) from the previous service frame from a buffer 940 in order to construct the superframe. Data storage unit 945 receives MAC bandwidth management commands that are stored as local and remote DEV (STBs) queue lengths from the previous superframe so that the CTA lengths can be varied. This information is forwarded to MAC bandwidth management entity 950, which forwards the CTA lengths to software module 930 in order to further support the construction of the superframe. Software module 930 also receives the MSDUs to be retransmitted from the previous frame from superframe retransmit buffer 955, which stores multiple MSDUs in each remote STB MAC protocol data unit (MPDU) and discards acknowledged MSDUs. The superframe constructed by software module 930 is stored in superframe construction buffer 960. The superframe constructed by software module 930 includes downstream MPDUs and upstream time. Superframe construction buffer 960 forwards the constructed superframes to superframe transmit buffer 965 in the form of multiple MSDUs in each remote STB MPDU. Superframe transmit buffer 965 forwards the superframes it receives from superframe construction buffer to superframe retransmit buffer 955. Superframe transmit buffer 965 forwards the complete MPDU to software module 970. Software module receives a delayed ACK from the remote STBs during the receive interval and timing information from the time clock 975. Software module 970 aggregates multiple MSDUs into each MPDU and forwards them to the physical layer module 980 for transmission. Software module 970 uses the timing based on the timing in the beacon and forwards the transmit data, transmit data rate, transmit length, transmit power level and transmit antenna control to physical layer module 980, which transmits the physical data protocol unit (PPDU) from the PNC to the designated remote STB.

Since FIG. 10 is depicting receive packet flows the description will begin and proceed from the right hand side of the diagram. A PPDU is received at physical layer software module 1005, which also receives input from time clock 1010. Physical layer software module forwards the received data, length, link quality indicator (LQI), received signal strength indicator (RSSI) and PHY receive errors to software module 1015. Software module 1015 breaks the PPDU into MPDUs which are aggregated MSDUs using timing based on the timing beacon and forwards the MPDUs to software module 1020, which performs the HCC calculations, isolates the complete MSDU frame or fragment, processes the frame check sequence, keeps track of correctly received MSDUs, constructs the delayed ACK in response to the delayed ACK request and filters the MSDUs so that only the correct MSDUs intended for the server are passed on to the server (master STB). Software module 1020 forwards the delayed ACK for the received MSDUs and discards the MSDUs not intended for the server (master STB). Software module 1020 receives physical characteristics and parameter from data storage unit 1025 in order to perform the above described functions. Software module 1020 forwards MAC commands such as delayed ACKS and bandwidth management messages to software module 1030, which separates the MAC commands and forwards the MSDU ACKs to MSDU ACK buffer 1035 and forwards the MAC bandwidth information elements (IEs) to MAC bandwidth management entity 1040. Software module 1020 also forwards MSDUs (mostly TCP ACKs) to software module 1045, which reconstructs completed MSDUs from fragments, stores fragments of incomplete MSDUs and puts MSDUs in the proper order. Software module 1045 is in communication with re-ordering frame construction buffer 1050 and receive MSDU fragment buffer 1055. Software module 1045 forwards the complete MSDUs to software module 1060, where the complete MSDUs are converted to Ethernet frames including frame check sequence and priority mapping. Software module receives forwarding tables and service flow information from data storage unit 1065 and forwards the Ethernet frames to the server (master STB).

FIG. 11 is the high level transmit packet flow for the PNC connected to the remote STB (video client). Ethernet frames are received by software module 1105, which filters and classifies incoming frames from the video client. Software module 1105 forwards the Ethernet frames to frame queue 1110. There is only one queue since all traffic should be going to the server (master STB). However, if multiple priorities are desired, then multiples queues are implemented—one queue for each priority group. The data in the queue is forwarded to software module 1115, which converts the Ethernet frames to IEEE 802.15.3 MAC frames including priority mapping, frame check sequence, fragmentation and HCC calculations. Software module 1115 receives forwarding table and service flow information from data storage unit 1120. Software module 1115 is also in communication with transmit MSDU transmit buffer 1125. Software module forwards multiple MSDUs to software module 1130, which constructs upstream MPDU for transmission within the next superframe. Software module 1115 also receives requests from software module 1130. Software module 1130 receives MSDU ACKs from the previous superframe from buffer 1135. Software module 1130 receives physical characteristics and parameters from data storage unit 1140 and receives CTA information from the beacon from data storage unit 1145. Software module 1130 receives MAC bandwidth management commands from software module 1150, which constructs bandwidth management message using local queue length information received from data storage unit 1155 and MAC bandwidth request responses (IEEE 802.15.3 MAC command used in a non-standard way to exchange queue information) from the previous superframe from data storage unit 1160. Software module 1130 receives MSDUs to be retransmitted from the previous superframe from superframe retransmit buffer 1165. There are multiple MSDUs in each MPDU. Superframe retransmit buffer 1165 also discards acknowledged MSDUs. Software module 1130 is in communication with construction buffer 1170, which is a buffer for upstream MPDUs for the next superframe. Construction buffer 1170 forwards the upstream MPDUs to superframe transmit buffer 1175, which forwards the upstream MPDUs to software module 1180. Superframe transmit buffer 1175 also forwards the upstream MPDUs to superframe retransmit buffer 1165. Software module 1180 aggregates multiple MSDUs into each MPDU using timing based on the beacon and passes the MPDUs to the physical layer software module 1185 for transmission. Software module receives time from time clock 1190 and receives delayed ACKs from the server (master STB) during the receive interval. Software, module 1180 forwards transmit data, transmit data rate, transmit length, transmit power level and transmit antenna control to physical layer software module 1185.

An approximation of the receive process in the remote DEVs is shown in FIG. 12. The receive process mostly consists of disassembling the superframe and then reconstructing Ethernet Frames, including reassembling fragmented frames. The receive side also checks for errors and prepares a DLY ACK (a type of bulk ACK) for transmission back to the PNC. The DLY ACKs are sent at the beginning of the CTA heading the opposite direction of the CTA within which the packet arrived. This is another deviation from the standard.

FIG. 12 is a high level receive packet flow diagram for the DEV-x connected to a video client (remote STB) so the description will begin and proceed from the right hand side of the diagram. Software module 1205 receives PPDU and forwards the received data, received errors, length, LQI and RSSI to software module 1215. Software module 1205 receives receive antenna control information from software module 1215 and receives timing information from time clock 1210. Software module 1215 receives MPDUs from physical layer software module 1205. Multiple MSDUs are aggregated into each MPDU. Software module 1215 receives timing from time clock 1210. Software module 1215 forwards MPDU pieces to software module 1220, which performs HCC calculations, isolate complete MSDU frames or fragments, processes frame check sequence, keeps track of correctly received MSDUs, constructs a delayed ACK in response to a delayed ACK request and filters MSDUs and forwards only correctly received MSDUs intended for the server (master STB). Software module receives physical characteristics and parameters from data storage unit 1225 and forwards delayed ACKs for the received MSDUs. Software module 1220 discards MSDUs not intended for the video client (remote STB) and forwards MAC commands to software module 1230, which separates MAC management messages and forwards MAC bandwidth responses to data storage unit 1235 and forwards MSDU ACKs from the remote STBs to MSDU buffer 1240. Software module 1220 forwards MSDUs to software module 1245, which reconstructs completed MSDUs from fragments, stores fragments of incomplete MSDUs and puts MSDUs in the proper order. Software module 1245 is in communication with re-ordering and frame construction buffer 1250 and receive MSDU fragment buffer 1255. Software module 1245 forwards complete MSDUs to software module 1260, which converts MAC frames to Ethernet frames including priority. Software module 1260 also receives forwarding table and service flow information from data storage unit 1265.

Referring to FIG. 13, the physical preamble and physical header make up one physical frame per CTA. Delayed ACK to a remote STB, queue status information request to remote STB and multiple data packets to a remote STB make up a collection of MAC frames with protected MAC headers. The above concatenated with any leftover time within the CTA make up the downstream CTA for the PNC to a remote STB.

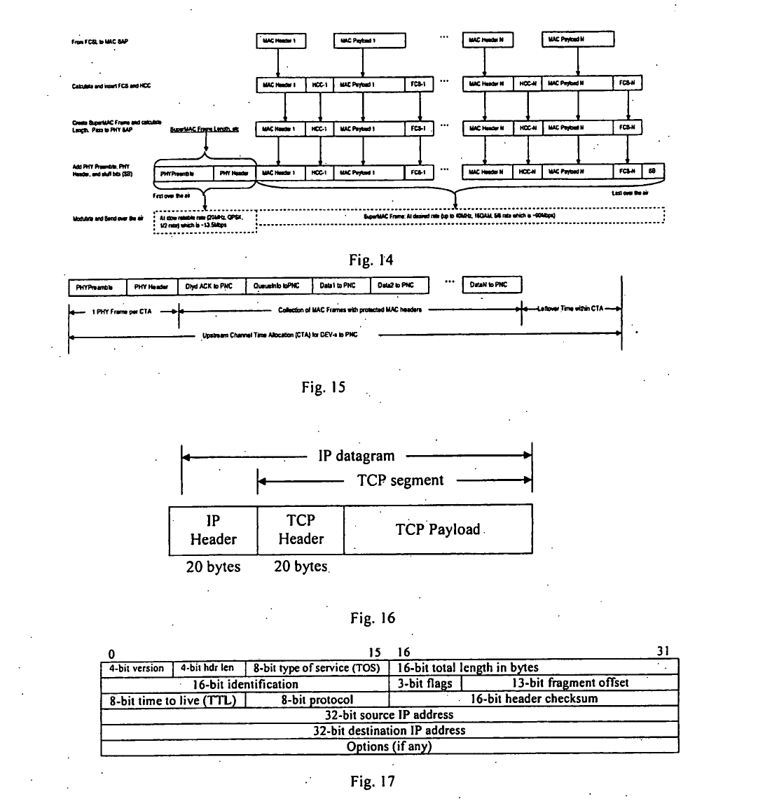

Referring now to FIG. 14, for each MAC payload there is a corresponding MAC header. The HCC is calculated and inserted after the MAC header and before the MAC payload. The FCS is calculated and inserted after the MAC payload. This is done for each MAC payload to create a SuperMAC frame. The SuperMAC frame length is part of the physical header, which is inserted ahead of the SuperMAC frame to make a CTA, which is modulated and transmitted over the air. The physical header is transmitted at a slow reliable rate and the SuperMAC portion of the CTA is transmitted at some desirable rate.

Transmission of frames within CTA 4, 5, & 6 are sent in a similar manner. An example of frames sent in one of those CTAs is shown in FIG. 15, which depicts a single upstream CTA (DEV-x to PNC), a single upstream CTA includes a physical frame and a collection of MAC frames with protected headers and any leftover time within the CTA. For the present invention, much of the upstream traffic will be TCP ACKs. Like the downstream CTA depicted in FIG. 13 the physical frame includes the physical preamble and the physical header. The collection of MAC frames includes the delayed ACK to the PNC, the queue information to the PNC and the data packets to the PNC. Note that this CTA includes a frame which carries queue status information back to the PNC. This queue status information may include the size of the queue (if that is variable), the number of frames in the queue, the average length of the frames, and the frame arrival rate at the input of the queue.

For this invention, it is assumed that the video streaming packets (downstream) are sent from the Master STB using TCP. Because of this, TCP ACKs will be generated in the opposite direction (upstream) of the video. These TCP ACKs add overhead that if eliminated, can free up time for more real traffic (i.e., downstream video). Additionally, because of the flow control mechanisms built into TCP and because of the extra delay added by the wireless bridge (due to buffers and CTAs), TCP may keep the video stream from reaching the rate that it really needs to reach.

First, TCP is briefly described so that the problem is better appreciated. Then a few cross-layer modifications at a high-level that may help solve the problem are presented. It should be noted that changing the TCP parameters themselves in the master STB and the remote STBs would be another way to solve this problem, but as has been stated several times, it is assumed that this is not possible.

TCP is a full-duplex connection-oriented transport protocol. TCP sends segments of data stream. UDP sends packets as presented. One feature of TCP is reliable delivery. This is assured through the use of TCP ACKs. Although this mechanism has proven beneficial for Internet traffic, its benefit for creating reliable delivery is questionable on a LAN that already has high reliability. Thus, the TCP ACKS add significant overhead. In the case of a bandwidth limited network, such as wireless, the disadvantage of that overhead is great.

TCP Encapsulation is shown in FIG. 16. The TCP header is prepended to the TCP payload. The IP header is prepended to both of these. The combination of the TCP payload and the TCP header is also called a TCP segment. The combination of the TCP segment and the IP header is also called an IP datagram.

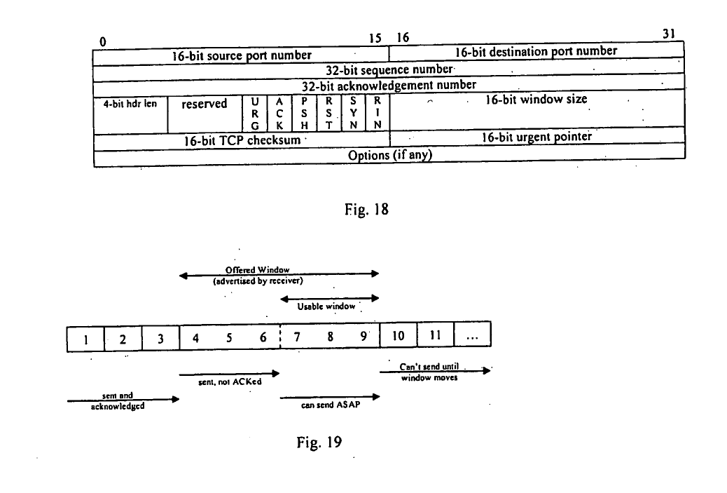

An IP header and a TCP header are shown in FIGS. 17 and 18 respectively. The IP header includes the destination IP address and the source IP address. Additionally, it includes a protocol number used for identifying it's payload. In the case of TCP, this number is 17. In the case of UDP, it is 6. The TCP header includes a destination port number and a source port number. The port numbers are used by the device at each end to identify the software application or code associated with that TCP connection.

Additionally, the TCP header includes several other fields important to the operation of the present invention. Since TCP is full duplex connection, each end maintains separate sequence number counter. The 32-bit sequence number is a byte counter, which is incremented by the source device for every packet that goes out that is part of the same TCP connection. The header also includes a 32-bit acknowledgement number that is used to inform a sender what the next byte is that the receiver expects (in other words, the receiver has successfully received up through byte-1). The opposite direction of the full-duplex TCP connection follows the same procedure.

The maximum segment size (MSS) is sent from the receiver to the sender, indicating the maximum segment size (in bytes) that it may receive. Typical TCP MSS's are 1024 (common), 536 (default when one end does not receive MSS from other end), 1460 on Ethernet, etc. The default of 536 reflects the fact that IP must be able to handle a minimum size of 576-byte packets (payload and TCP and IP headers). So, traffic sent to the Internet is usually limited to this number. External versus internal routes are determined by path maximum transfer unit (MTU) discovery.

The checksum covers the TCP header and data and is used to determine if the frame has been received correctly. The most common option field is the maximum segment size (MSS), which is sent when the connection is being established. ACK field means that the acknowledgement value is valid.

The sequence numbers are used to implement a sliding-window protocol without selective retransmission or negative acknowledgements. It can be used in a “Go-Back-N” scheme or a “Stop-n-Wait” scheme. TCP sliding window operation is illustrated in FIG. 19. Basically, a limited number of unacknowledged bytes are allowed “in the network” at any given time. When bytes are acknowledged, the trailing part of the window moves left. The leading end of the window moves left when bytes are acknowledged and/or a bigger window is advertised. The number of bytes left in the usable window depends on the window size and how many bytes have already been sent. The destination sets window size based on the number of bytes it can receive (perhaps based on receive buffer size). The sliding window results in the well known bandwidth delay product limitation shown below.

Window Size(Capacity)=effective BW(bits/sec)×Round Trip Time(sec)

TCP originally only had a 16-bit window size, which meant that when the TCP receiver set the window size to its maximum, there were only 64 Kbytes allowed in the network. The window size has been modified to include a scaling option that allows many more bytes in the network to be unacknowledged. However, because of legacy implementations and because it works “most of the time,” many implementations still only use a 16-bit sliding window. The finite TCP sliding window can cause problems in the target application due to the high bandwidth needed for video and the delay needed for a TDMA MAC wireless bridge.

To see how the sliding window could negatively impact the exemplary bridging system, consider the following example. For the case where the length of the superframe is fixed at 5 or 10 msec and CTAs are fixed, Table 1 shows some representative values. Table 2 shows the approximate number of packets we might expect within each CTA using the method of MPDU aggregation shown here and a few other specific assumptions (e.g., video packet size). The round trip time (RTT) is the time from when a TCP packet is sent to the time that a TCP ACK associated with only that segment is received. If the superframe is 10 msec, then the RTT is at least 20 msec. It will actually be higher due to packets in transmit queues and retransmissions at the MAC-level. At 20 Mbps and a 20 msec delay, the sliding window would have to be at least 50 Kbytes to allow the stream to run at the intended rate. It is likely that the extra buffering and the fact that data comes in asynchronous to the start of a CTA will cause the stream to slow down in this example. Furthermore, the TCP sliding window may be set to something slower than 50 Kbytes.

TABLE 1
SuperMAC Frame Sizes and Recommended CTA Lengths

| | | 20 MHz, QPSK, | Assumes 40 MHz, | | | Assumes 40 MHz, | | | |
|---|---|---|---|---|---|---|---|---|---|
| Superframe | | 1/2 rate | 16QAM, 5/6 rate coding | | | 16QAM, 5/6 rate coding | | | |
| Length | | Beacon | CTA-1 | CTA-2 | CTA-3 | CTA-4 | CTA-5 | CTA-6 | Leftover+ |
| 5 msec | Frame Lengths* | 100 usec | 1.3 msec | 1.3 msec | 1.3 msec | 96 usec | 96 usec | 96 usec | |
| | Recommended | 116 usec | 1.4 msec | 1.4 msec | 1.4 msec | 228 usec | 228 usec | 228 usec | 0 usec |
| | Allocated | | | | | | | | |
| | Time+# | | | | | | | | |
| 10 msec | Frame Lengths* | 100 usec | 2.44 msec | 2.44 msec | 2.44 msec | 136 usec | 136 usec | 136 usec | |
| | Recommended | 116 usec | 3.0 msec | 3.0 msec | 3.0 msec | 240 usec | 240 usec | 240 usec | 160 usec |
| | Allocated | | | | | | | | |
| | Time+# | | | | | | | | |

*For CTA-1, 2, 3 based on 1404-byte payload MAC Frames each with 1300 bytes of video data.
For CTA-4, 5, 6 based on 40-byte MAC payload for TCP ACKs
+Each Frame must be followed by a 16 usec SIFS.
#CTA-4, 5, 6 sized to accommodate at least 1 full size frame to avoid fragmentation

TABLE 2
Approximate Number of Data Frames per CTA

| | CTA-1 | CTA-2 | CTA-3 | CTA-4 | CTA-5 | CTA-6 |
|---|---|---|---|---|---|---|
| Superframe | Video | Video | Video | TCP | TCP | TCP |
| Length | Frames* | Frames | Frames | ACKs+ | ACKs | ACKs |
| 5 msec | 10# | 10 | 10 | 10 | 10 | 10 |
| 10 msec | 19# | 19 | 19 | 19 | 19 | 19 |

*For CTA-1, 2, 3 based on 1404-byte payload MAC Frames each with 1300 bytes of video data
+For CTA-4, 5, 6 based on 40-byte MAC Payload for TCP ACKs
#Number of Frames per CTA chosen to meet bit rate requirements (i.e., ~20 Mbps per for video data)

There are also several timeouts of interest. Re-transmission timeouts can be based on a measurement of RTT, but are typically set to 500 msec. Re-transmission timeouts are used to initiate the re-transmission of a TCP segment that has not been acknowledged. Another timer is sometimes used to delay when the TCP ACK is returned to the transmitter. This is to allow data to become available for the payload. This timer is typically set for 200 msec and would increase the RTT for the present application.

If TCP receiver receives a packet with errors, it discards it and waits for the sender to re-transmit the packet. If TCP sender does not receive ACK within the timeout period, typically 500 msec, the TCP sender re-transmits the packet. For a video streaming application, this is too late for the receiver to use so the packet might as well be discarded.

“Slow Start” is a relatively newer feature of TCP. In this feature, the rate at which new packets should be injected into the network is the rate at which the acknowledgements are returned by the other end. This effectively adds another window to the sender's TCP known as the congestion window. This is mostly used for avoiding congestion when going through routers.

In the present invention, there are two methods for reducing the effects of TCP ACK overhead and TCP windows and congestion management. The two methods can be combined to form a third method. The methods of the present invention involve the MAC layer participating in a limited way in the TCP ACK process. The video stream packets and the returning ACKs are identified as being part of a TCP connection. It is well known that TCP packets belonging to the same connection (or stream) can be uniquely identified by the destination IP address, source IP address, TCP source port number and TCP destination port number. For the target application, most of the packets within the same transmit queue will likely belong to the same TCP connection. The TCP ACKs with valid sequence numbers can, thus, be determined by looking at the ACK flag in the TCP header.

In the first method, it is desirable to reduce the number of TCP ACKs that are actually transported across the wireless link from the remote bridge device and the master bridging device. Since the present invention uses a TDMA MAC, transmissions from the remote STB to the master STB happen in bulk every 5 or 10 msec depending on the length of a superframe. For transmissions from the remotes STB/device to the master STB/device, the remote STB takes packets out of its transmit queue and assembles them into a series of frames (or aggregated frames) for transmission. In this exemplary application, all of this traffic is destined for the master STB.

The remote bridge device examines the IP and TCP headers of frames in the transmit queue and determines which are TCP ACKs from the same TCP connection. For those packets, the sequence number in the TCP header is then read. Assuming no payload in those packets, the remote bridge device only needs to send the highest sequence number since with TCP that sequence number includes all lower sequence numbers. If one of the packets includes a payload, then that particular packet can be the one returned with the proper sequence number set in the header. If more than one of the TCP ACK packets contains data in its payload, it is also be sent with the sequence number repeated. This will effectively eliminate all redundant TCP-ACK-only-packets from the transmit queue. This allows for a shorter CTA to be allocated to the remote device/STB leaving more time for the CTAs assigned to the master device/STB and therefore more time allocated to downstream video transmission.

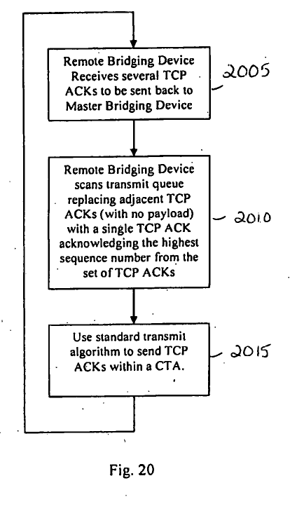

FIG. 20 is a high level flowchart of the first method of the present invention as practiced at the remote bridge device. At 2005 the remote bridge device receives several TCP ACKs that are to be forwarded to the master bridge device. At 2010 the remote bridge device scans its transmit queue replacing adjacent TCP ACKs that have no payload with a single TCP ACK acknowledging the highest sequence number from the set of TCP ACKs. At 2015 the single aggregate TCP ACK is forwarding to the master bridge device within a CTA. The process is repeated starting at 2005.

This first method reduces the overhead of TCP transmission ACKs, but it is still possible for TCP packets to be late and re-transmitted at the TCP level. Since TCP re-transmissions are based on a fairly long timeout, they are not much use for a real-time video stream. A TCP-level re-transmission could cause even worse problems than if the packet had arrived on time with a few errors since many video coder-decoders (CODECS) include error concealment schemes.

In the second method of the present invention, local TCP ACKs to be returned to the master device/STB are generated by the master bridge device. That is, the master device/STB is fooled into thinking that the downstream packet has already been received by the remote device/STB. Since the master device/STB receives the TCP ACK, it will not re-transmit that data/information. So, if for some reason the downstream data is received in error, even after several MAC-level re-transmissions, the downstream video data is still forwarded to the remote device/STB. However, as has been pointed out, for video streaming, “relatively on-time with a few errors” is better than “late and correct.”

This method can be used on all TCP traffic from the master device/STB or it can be used on only a specific TCP connection. In either case, the master bridge device keeps track of each TCP connection separately. As has been pointed out, TCP traffic is identified in the IP header by the protocol number and the stream itself is uniquely identified by the source and destination IP addresses and the source and destination TCP port numbers.

It is best to only use this method on the video stream itself for several reasons. Although it is best for video stream packets to be passed to the remote device/STB on-time, even if in error, other less frequent data traffic (e.g., box control), might need to arrive correctly. Additionally, since each TCP connection needs to be managed separately, managing N TCP connections requires N times more resources (i.e., data structures, etc.) than managing one TCP connection to each remote device/STB. Furthermore, most of the potential efficiency increase is available in the video stream since the exemplary application is downstream video distribution. Because of all of this, it is desirable to only generate local TCP ACKs for the video stream connection, which is the target application.

The master bridging device can use one of several methods to identify the video stream. In some applications, the STBs and the bridging devices might come from one manufacturer. The TCP port numbers used for video distribution may be known to the bridge devices ahead of time (i.e., built in during design) or it may be possible to manually enter that information into the bridging devices, either directly or over a network or other interface. It is possible that the bridging devices identify the stream in some other way, perhaps even direct communication with the STB, which may be in direct communication with the service provider's network.

It is possible for the master bridging device to identify the video stream from its characteristics. Most video streams (from a broadcaster) are in the range of 1-2 Mbps. High definition video is closer to 15-20 Mbps. The master bridging device can “sniff” the TCP connection setup packets and then watch the stream for some period of time (e.g., 1 second). If it appears it is a constant stream, the master bridge device can commence using this method.

The master bridge device keeps track of the TCP Sliding Window, TCP sequence numbers, and its own transmit queue. If TCP frames are arriving too often from the master device/STB, then the master bridge device withholds a TCP ACK until the queue level goes down. The method of the present invention is a form of flow control.

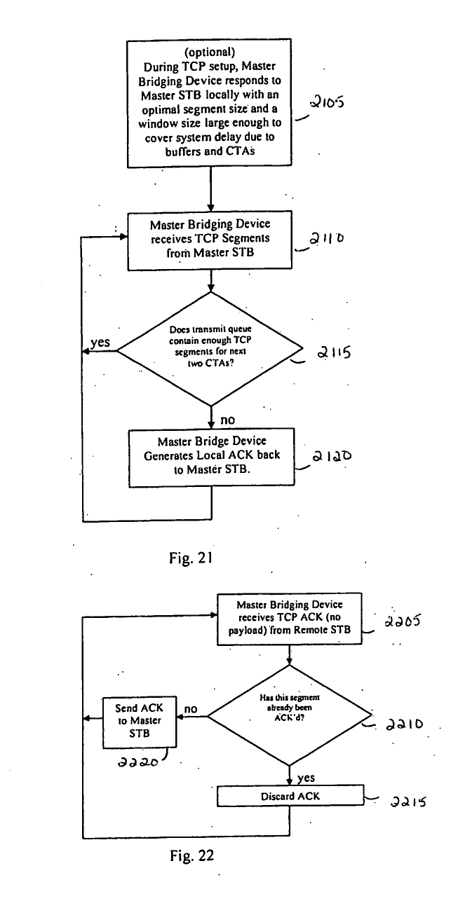

FIG. 21 is a high level transmit flowchart of the second method of the present invention as practiced at the master bridging device. Optionally, at 2105 during TCP setup, the master bridge device responds to the master device/STB locally with an optimal segment size and a TCP window size large enough to cover system delay due to buffering and CTAs. At 2110 the master bridge device receives TCP data segments from the master device/STB. A test is performed at 2115 to determine if the transmit queue contains enough TCP data segments for a pre-determined number of CTAs (for example, two CTAs). If there are enough TCP data segments then act 2110 is executed again. If there are not enough TCP data segments then the master bridge device generates a local TCP ACK at 2120 to return to the master device/STB and then act 2110 is executed again.

Since a TCP connection is a full duplex connection, there are also ACKs heading from the remote device/STB logically to the master device/STB. In this case, the remote device/STB performs the same process on the upstream packets that the master device STB performed on the downstream packets.

The master bridge device also intercepts the TCP ACKs actually being returned from the remote device/STB to make sure they do not get sent to the master device/STB. The master bridge device uses the information in these TCP ACKs to determine where the remote device/STB stands regarding processing incoming packets. Alternatively, the TCP ACKs are intercepted by the remote bridge device and a summary report is forwarded to the master bridge device if desired. It is also possible that the remote bridge device throws away the intercepted TCP ACKs.

FIG. 22 is a high level flowchart for forwarding remote TCP ACKs in the master bridge device. At 2205 the master bridge device receives TCP ACKs (no payload) from a remote device/STB. A test is performed at 2210 to determine if the received data segment has already been acknowledged. If the data segment has already been acknowledged then the TCP ACK is discarded at 2215 and the process is repeated starting at 2205. If the data segment has not already been acknowledged then a single TCP ACK is forwarded to the master device/STB at 2220.

The remote bridge device is aware of packets that have been transmitted at the MAC level several times. The packets may be late and they may even be in error once they are finally received in the remote bridge device. In any case, the data segment is still forwarded to the remote device/STB since the remote device/STB is also keeping track of which bytes have been received and acknowledged.

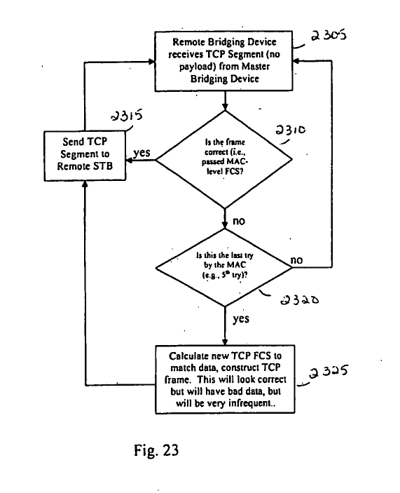

FIG. 23 is a high level flowchart of the second method of the present invention as practiced in the remote bridge device. At 2305 the remote bridge device receives TCP data segments (no payload) from the master bridge device. A test is performed at 2310 to determine if the frame is correct (if the frame passed the frame check sequence). If the frame is correct then the frame is forwarded to the remote device/STB at 2315 and the process is repeated starting at 2305. If the frame is not correct then another test is performed at 2320 to determine if this is the last attempt by the MAC layer to re-transmit (fifth attempt). If this is not the last attempt then the process is repeated starting at 2305. If this is the last attempt then at 2325 a new frame check sequence is calculated to match the data and a new TCP frame is constructed. This new frame will look correct but have bad/incorrect data and should occur infrequently.

An advantage of the second method of the present invention is the ability to fool the source into thinking that the packets have been acknowledged. This allows more packets to be in the communication path, effectively lengthening the window and the resultant average bit rate. This average bit rate must be kept above the natural streaming rate of the video.

The third method combines the two methods described above. The TCP ACKs are generated locally by one of the bridge devices (master or remote) as in the second method, however the TCP ACKs being returned by the remote STB are combined as described in the first method.

Even though description above has focused on a wireless bridging system with one master and three remote devices suitable for a high definition video distribution application, it should be clear to those trained in the art that the methods of the present invention as described above can be extended to a general wireless CSMA or TDMA MAC and even to wired MACs running on common media (e.g. powerline).

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components, (or the process steps) may differ depending upon the manner in which the present invention is programmed. Given the teachings herein, one of ordinary skill in the related art will be able to contemplate these and similar implementations or configurations of the present invention.

1. A method for managing acknowledgements, said method comprising:
identifying data packets and acknowledgements with a connection;
determining which of said acknowledgements can be eliminated;
replacing said acknowledgements that can be eliminated with a single acknowledgement; and
transmitting said single acknowledgement.

2. The method according to claim 1, wherein said identifying act further comprises examining headers in a transmit queue.

3. The method according to claim 2, wherein said examining act further comprises examining a flag in said headers.

4. The method according to claim 2, wherein said determining act further comprises determining which acknowledgements are from a common connection.

5. The method according to claim 4, further comprising reading sequence numbers in said headers.

6. The method according to claim 5, wherein said single acknowledgement has a highest sequence number of said data packets being acknowledged.

7. The method according to claim 1, further comprising:
determining if there is a payload packet to be transmitted; and
transmitting said single acknowledgement in said payload packet.

8. The method according to claim 1, wherein said connection is a TCP connection.

9. The method according to claim 1, wherein said acknowledgements are TCP acknowledgements and said single acknowledgement is a TCP acknowledgement.

10. A method for managing acknowledgements, said method comprising:
receiving a data segment;
keeping track of connections;
determining if there are enough data segments for a pre-determined number of channel time allocations; and
generating said acknowledgments for a selected connection if there are enough data segments for said pre-determined number of channel time allocations.

11. The method according to claim 10, further comprising withholding acknowledgements if frames are arriving too frequently.

12. The method according to claim 10, further comprising:
intercepting a segment acknowledgement forwarded by a remote device;
determining if said segment has already been acknowledged;
discarding said segment acknowledgement if said segment has already been acknowledged; and
forwarding said segment acknowledgement if said segment has not already been acknowledged.

13. The method according to claim 10, further comprising receiving a summary report.

14. The method according to claim 10, wherein said connections are TCP connections.

15. The method according to claim 10, wherein said acknowledgements are TCP acknowledgements.

16. The method according to claim 10, further comprising aggregating said acknowledgements in to a single acknowledgement.

17. An apparatus for managing acknowledgements, comprising:
means for identifying data packets and acknowledgements with a connection;
means for determining which of said acknowledgements can be eliminated;
means for replacing said acknowledgements that can be eliminated with a single acknowledgement; and
means for transmitting said single acknowledgement.

18. The apparatus according to claim 17, wherein said means for identifying further comprises means for examining headers in a transmit queue.

19. The apparatus according to claim 18, wherein said means for examining further comprises means for examining a flag in said headers.

20. The apparatus according to claim 18, wherein said means for determining further comprises means for determining which acknowledgements are from a common connection.

21. The apparatus according to claim 20, further comprising means for reading sequence numbers in said headers.

22. The apparatus according to claim 21, wherein said single acknowledgement has a highest sequence number of said data packets being acknowledged.

23. The apparatus according to claim 17, further comprising:
means for determining if there is a payload packet to be transmitted; and
means for transmitting said single acknowledgement in said payload packet.

24. The apparatus according to claim 17, wherein said connection is a TCP connection.

25. The apparatus according to claim 17, wherein said acknowledgements are TCP acknowledgements and said single acknowledgement is a TCP acknowledgement.

26. An apparatus for managing acknowledgements, comprising: means for receiving a data segment;
means for keeping track of connections;
means for determining if there are enough data segments for a pre-determined number of channel time allocations; and
means for generating said acknowledgments for a selected connection if there are enough data segments for said pre-determined number of channel time allocations.

27. The apparatus according to claim 26, further comprising means for withholding acknowledgements if frames are arriving too frequently.

28. The apparatus according to claim 26, further comprising:
means for intercepting a segment acknowledgement forwarded by a remote device;
means for determining if said segment has already been acknowledged;
means for discarding said segment acknowledgement if said segment has already been acknowledged; and
means for forwarding said segment acknowledgement if said segment has not already been acknowledged.

29. The apparatus according to claim 16, further comprising receiving a summary report.

30. The apparatus according to claim 16, wherein said connections are TCP connections.

31. The apparatus according to claim 26, wherein said acknowledgements are TCP acknowledgements.

32. The apparatus according to claim 26, further comprising means for aggregating said acknowledgements into a single acknowledgement.
